(19) United States
(12) Patent Application Publication
(10) Pub. No.: US 2014/0258143 A1
(43) Pub. Date: Sep. 11, 2014

(54) COMPUTER SYSTEM FOR SCORING PATENTS

(71) Applicant: CDC PROPRIETE INTELLECTUELLE, PARIS (FR)

(72) Inventors: Arnaud LAROCHE, Paris (FR); Bertrand Fisch, Paris (FR); Julien Damon, Saint Cloud (FR)

(21) Appl. No.: 13/787,288

(22) Filed: Mar. 6, 2013

(51) Int. Cl. G06Q 50/18; G06Q 10/06

(52) U.S. Cl. CPC G06Q 50/184; G06Q 10/06
USPC 705/310

(57) ABSTRACT

The invention discloses a system to score assets such as patents based on an event on which information is publicly available and is correlated to a number of intrinsic and extrinsic variables which characterize the assets. More specifically, the invention improves over the prior art by taking due account of yearly life expectancy statistics of patents of the same family in multiple jurisdictions where related patents owned by the same assignee have been filed. For doing so, the system of the invention provides a method to use statistical models of the semi-parametric type such as Cox proportional hazard models or the parametric type, such as Weibull accelerated failure models. These models yield a much improved precise estimation of patents families filed in multiple jurisdictions, the possibility to make available to the users the breakdown of the explanatory power for each relevant variable and validation criteria and the option to choose between different models the one best fitted to their usage scenario.

### FIELD OF THE INVENTION

The present invention relates to a computer system for rating certain classes of assets which confer to their owner certain benefits in return for a cost to be paid. More specifically, the invention is particularly well adapted to rate patent families, which confer to their assignee the right to exclude others from practicing the patented invention in a number of countries in return for a price: the cost of disclosing the invention, plus the cost of prosecuting the patent application up to grant in a number of jurisdictions, plus the cost of paying maintenance fees to a number of patent offices.

### BACKGROUND

The economic theory has provided some background to base the valuation of patents on the observation of the behaviour of their owners, which is supposed to be rational: a patentee will normally pursue patent protection if the expected benefits from obtaining the patent and then maintaining it alive are higher than the sum total of the expected costs. If, at a moment in time, the expected benefits drop under the expected costs, a rational patentee will normally abandon the patent (ie stop paying for the maintenance fees). See for instance, Schankerman, Mark and Pakes, Ariel (1986) “Estimates of the value of patent rights in European countries during the post-1950 period”. The economic journal, 96 (384). pp. 1052-1076. ISSN 1468-0297.

The decision to maintain a patent in force being then deemed to be a good representation of the value of the patent, methods have been designed to correlate maintenance statistics with intrinsic and extrinsic factors which characterize a population of patents so as to identify the best statistical predictors of the value of this population or of a definite patent. Such methods are disclosed by U.S. Pat. Nos. 6,556,992 and 7,657,476 to Barney. According to the teachings of the '992, a number of independent variables for two samples of patents with known or assumed features which are preferably sufficiently different (a sample A of patents for which the 8^{th} annuity has been paid and a sample B of patents for which the 8^{th} annuity has not been paid) are analysed to adjust the coefficients of a number of independent variables of a multi covariate regression model of the dependent variable “Probability that the 8^{th} annuity is paid” so that the statistical accuracy of the model and the percentage of variance explained by the variable be optimized. Significant independent variables which are cited by Barney are: the number of independent claims, the length of the shortest independent claim, the forward and backward citations, the first patent class, etc. . . . . According to the teachings of the '476, we can calculate an overall score of a patent having definite features of the type just cited and then a life expectancy of said patent may be approximated by using a best fit of an expected distribution of life expectancies to the distribution of scores. The system disclosed by Barney has though the following limitations that the present invention overcomes.

First, most patent systems in the world, except the US system, are based on yearly maintenance fees, not three annuities. The consequence of this difference is that, instead of using a maximum of three simple explained variables “Probability that the 4^{th} annuity is paid”/“Probability that the 8^{th} annuity is paid”/“Probability that the 12^{th} annuity is paid” it is possible, with the maintenance statistics of other patent offices, to build life expectancy or survival models which can be more accurate than the prior art models.

Also, the worldwide patent system is fragmented: patent rights are generally granted by national bodies and in some limited cases only by international institutions such as the European Patent Office. An invention has in general the potential to be exploited across borders. This will require the inventor to file patent applications before a number of patent offices to be able to enjoy the fruits of his innovation. Patentability will be assessed in relation to different patent laws. Therefore, sophisticated users will decide to tune their maintenance policy to the specificities of each country. Indeed, taking into account the maintenance decisions made in the countries where a patent application has been validated will also improve the accuracy of the model.

### SUMMARY OF THE INVENTION

It is an object of the present invention to provide a computer system which greatly improves the accuracy of the scoring of the patents by taking account of the global life expectancy of patents in multiple jurisdictions.

To this effect, the present invention discloses a computer system for scoring at least one patent/patent application, said system comprising a database of patents/patent applications filed in at least one jurisdiction; said database comprising data representative of the maintenance fees paid or not paid at each payment term for a collection of patents/patent applications comprising said at least one patent/patent application, and data representative of variables which are related to said maintenance fees paid or not paid at each payment term, a statistical model representative of said relations between said variables and said maintenance fees paid or not paid at each payment term, wherein said statistical model takes into account at least one of a yearly survival probability of payment of maintenance fees and maintenance data in more than one jurisdiction.

Advantageously, said statistical model takes into account a yearly survival probability in more than one jurisdiction.

Advantageously, the parameters of said statistical model are adjusted on a first subset of said database and validated on a second subset of said database, said subsets comprising uncensored and censored data.

Advantageously, said statistical model is of one of a parametric or semi-parametric type.

Advantageously, said model is one of a Cox proportional hazard model and an accelerated failure time model with a Weibull distribution.

Advantageously, said model is one of a proportional hazard Cox model which is stratified and an accelerated failure time model with a Weibull distribution model which is stratified.

Advantageously, the strata of the stratified model are one of the international patent classes, the US patent classes and classes representative of the economic activities.

Advantageously, the strata of the stratified model are defined by the three digits international patent classes codes.

Advantageously, a first model of a semi-parametric type is first used to select the variables which have a statistically significant impact on the life expectancy of a patent and a second model of a parametric type is then used to with the same variables to determine best fit parameters.

Advantageously, maintenance data in more than one country are compounded to determine an overall score of said patent/patent application by weighting the maintenance data of each country by one of the rank of the death the patents/patent applications in a country relative to the number of available countries at the time of filing of said patents/patent applications and the life expectancy in a country relative to the maximum life expectancy of said patents/patent applications in the countries where they were filed or could have been filed.

Advantageously, different country weights are calculated for one of each international patent class, each US patent class and each of a series of class representative of the economic activities.

Advantageously, the country weights are normalized for the countries available for designation at the time of filing the patent applications in the database.

Advantageously, the predictive power of the model is assessed by comparing the high/low scores predicted by the model to the actual high/low scores measured from the statistics of an overall sample.

Advantageously, the high/low score patent families defined by set cut-off percentiles of scores are withdrawn from the database, wherein the remaining database is used to define different stratified statistical models wherein strata are defined by groups of percentiles of scores.

Advantageously, the life expectancy of a patent application with certain features is calculated as the product of the life expectancy of a patent with said features having matured to grant by the probability of grant.

The invention also provides a computer process for scoring at least one patent/patent application, said process comprising populating a database of patents/patent applications filed in at least one jurisdiction; said database comprising data representative of the maintenance fees paid or not paid at each payment term for a collection of patents/patent applications comprising said at least one patent/patent application, and data representative of variables which are related to said maintenance fees paid or not paid at each payment term, estimating a statistical model representative of said relations between said variables and said maintenance fees paid or not paid at each payment term, wherein said statistical model takes into account at least one of a yearly survival probability of payment of maintenance fees and maintenance data in more than one jurisdiction and a user obtains a score said patent/patent application from said model.

Advantageously, said user is given a breakdown analysis of the explanatory power of each variable on the overall score.

In another embodiment, the invention also provides a computer process for scoring at least one patent/patent application, said process comprising populating a database of patents/patent applications filed in at least one jurisdiction; said database comprising data representative of the maintenance fees paid or not paid at each payment term for a collection of patents/patent applications comprising said at least one patent/patent application, and data representative of variables which are related to said maintenance fees paid or not paid at each payment term, estimating more than one statistical model representative each of some of said relations between said variables and said maintenance fees paid or not paid at each payment term, wherein said statistical models takes into account at least one of a yearly survival probability of payment of maintenance fees and maintenance data in more than one jurisdiction and a user is given the option to choose the scoring model and obtains a score for said patent/patent application from the model he chooses.

Also, the invention offers the advantage of providing specific means for evaluating the predicting power of the algorithm of the scoring system. One of the principal uses of the system of the invention is to be able to discriminate between high and low scores with enough confidence. The invention provides such means.

Another advantage is to be able to evaluate the contribution of each independent variable to the life expectancy of a definite patent.

Another advantage is that the system of the invention is, thanks to some specific embodiments, capable of providing an overall rating of a family of patents.

### BRIEF DESCRIPTION OF THE DRAWINGS

The invention will be better understood and its advantages will become even more apparent when looking at the appended figures which represent embodiments of the present invention:

FIG. 1 displays a table of different approaches to patent value;

FIG. 2 displays a model of the rational decision making process of a patent owner;

FIG. 3 illustrates the input data of a patent scoring model of the prior art;

FIG. 4 illustrates a survival function of a population of patents according to an embodiment of the invention;

FIG. 5 illustrates a distribution by filing date of a patent sample and censored patents percentage in an embodiment of the invention;

FIG. 6 illustrates an exemplary interpretation of the results of a survival model to analyze the impact of the priority country on the average lifetime of a patent in an embodiment of the invention;

FIGS. 7a, 7b and 7c illustrate the calculation of weighting coefficients of the life expectations of a patent in multiple patent jurisdictions in an embodiment of the invention;

FIGS. 8a, 8b and 8c illustrate the theoretical calculation of the confidence level of the lifetime computation in an embodiment of the invention;

FIG. 9 illustrates the correlation between the lifetime expectancy and a specific variable correlated thereto in an embodiment of the invention;

FIG. 10 displays the computation of a user test to assess the predicting power of a model in an embodiment of the invention;

FIG. 11 displays a flow chart of a process to implement an embodiment of the invention.

### DETAILED DESCRIPTION OF SOME EMBODIMENTS

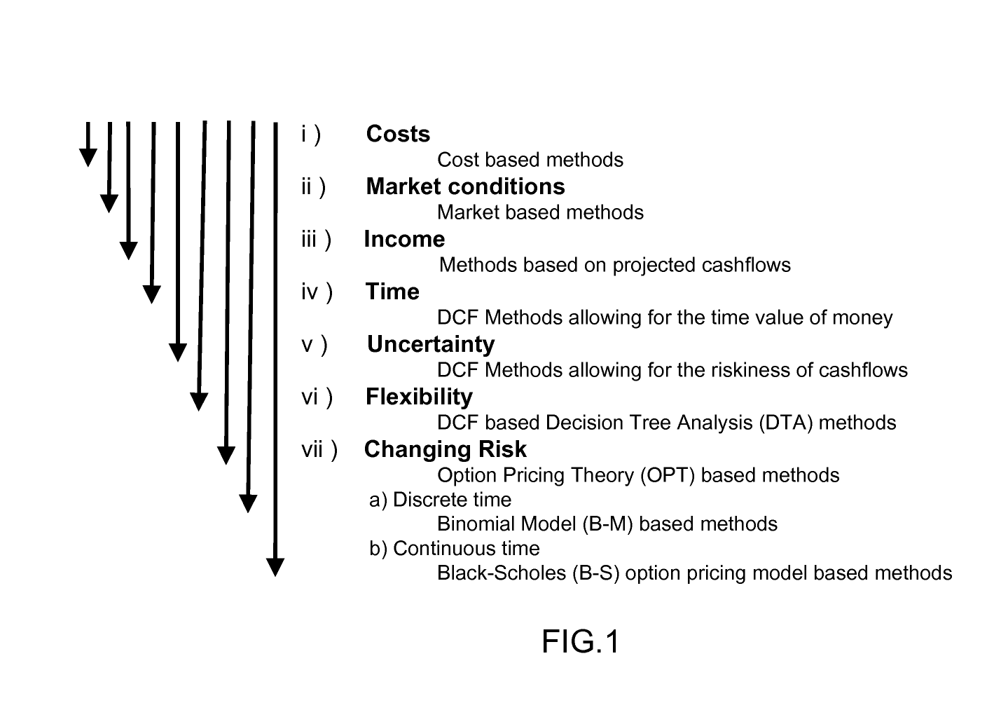

FIG. 1 displays a table of different approaches to patent value.

This table is abstracted from an article by Robert Pitkhetly (The Valuation of Patents. A review of patent valuation methods with consideration of option based methods and the potential for further research. The Said Business School, University of Oxford—Oxford Intellectual Property Research Center, 1997)

These approaches have all the objective of determining an individual absolute value in a monetary currency.

The cost approach is based on a summation of the costs of acquiring a definite patent. When the patent has been developed internally by an organization, it is debatable to include or not the cost of R&D, since this cost may produce other benefits than the simple production of a patent. Also, cost is seldom an indication of the price that a third party may be willing to pay for acquiring this patent. Indeed, this approach is not used very often, except for accounting purposes.

The market based approach consists in using market comparables to determine the value of a definite patent. Due to the rarity and confidentiality of transactions of this kind, this approach can be very seldom used efficiently.

The methods based on projected cash-flows (discounted for time or not, and possibly for risk also, or not) can be used only when such cash-flows can be determined with enough certainty. This can be the case when licensing income or cash-flows derived from the sale of a definite product can be apportioned to the patent to be evaluated. When this is the case, a discounted cash-flow computation will give a simple evaluation.

The selection of an appropriate discount rate is always a delicate decision. When the time value of money is only factored, classical methods such as the calculation of a weighted average cost of capital can be used. This approach normally integrates the risk of investing money in an established business on the capital markets. When the business case is venture investment, this approach underestimates the risk factor and it is necessary to use subjective discount rates which are based on the practice of venture investors.

Also, apportionment of cash-flows to a definite patent may be difficult: when a single patent is licensed, the valuation of this patent is straightforward. But it is seldom the case: when more than a single patent is licensed, it is necessary to evaluate the relative portions of the licensed patents which are attributable to the patent to be evaluated. When a patent is practiced by an industrial entity, it is necessary to apportion the cash-flows between the different assets which contribute to the generation of these cash-flows. In general, these assets will comprise other technical assets, such as copyrighted software and know-how, marketing assets such as trademarks, sales and distribution channels, marketing investments, and management assets, such as people, processes, logistics and information systems. Various approaches can be used to determine the relative values of these contributing assets, but their use supposes to dig deep into each business case and is therefore time consuming.

A variant of the income approach has been developed, which is based on Decision Tree Analysis. Multiple business scenarios are built, depending on different market conditions and events, and the computed DCF values are weighted by their probability of occurrence. This method may yield results which look prima facie more precise because they can be adapted to varying business conditions. But building the various scenarios is time consuming and adds complexity and variance to the results.

A more sophisticated approach of DTA analysis is based on the theory used to price financial options. This approach is different from a DTA analysis in that the various scenarios are not attributed an a priori probability but are weighted by a probability which is generated by a probabilistic model. Various models can be used. One of the significant drawbacks of this approach is that it is difficult to track the rationale for the final valuation.

None of these methods has become prevalent on the market and no standard has emerged. One of the reasons is that the cost of implementing these methods is very significant, because they require deep and broad expertise. This is only justified when there are significant economic benefits to be derived from their implementation. One prerequisite would be to have an indication that the benefit will be worth the expense. This is certainly the case when dealing with patents which are litigated, and one field (if not the only one) where these methods are widely used is forensic expertise. Since less than 2% of the patents in force are ever litigated, this leaves the problem of valuation of the 98% other patents unresolved.

This is why methods to rapidly score lots of patents have been developed. These methods allow a selection of the patents which will be worth the expense of a detailed valuation. This is an object of the present invention to improve these methods.

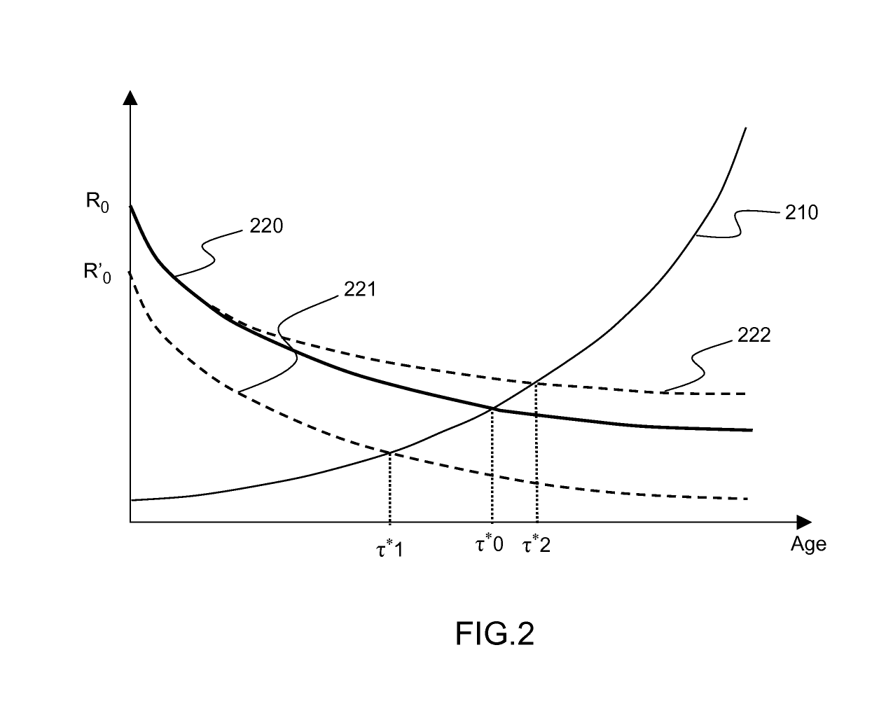

FIG. 2 displays a model of the rational decision making process of a patent owner.

This graph is extracted from a publication by Marc Baudry (La construction d'un outil de notation des brevets, Complément C, Rapport du Conseil d'Analyse Economique n^{o} 94, La Documentation Française, Paris).

Some of the prior art patent rating methods, such as the one disclosed by U.S. Pat. No. 6,556,992 to Barney, are based on the observation of the decisions of the patent owners to keep their patents alive or abandon them.

The underlying assumption is that the patent owners have a rational behaviour. They keep alive the patents which have a value for them and discard the others. FIG. 2 illustrates the microeconomic reasoning behind this behaviour.

Curve 210 represents the forecasted evolution of the yearly cost of maintaining a patent B₁ alive; the cost at time zero is the initial cost of filing the patent application; then prosecution costs are added from time to time; finally, maintenance fees are paid, annually from an initial date in most countries, and every four years from grant in the US; costs are generally escalating with time, hence the form of the curve.

Curve 220 represents the forecasted evolution of the yearly economic benefits to the patent owner; these may comprise a premium price charged to the clients, savings in the costs of a product, etc. . . . ; they generally level off with time, with competition from substitute products, but may in some cases keep increasing with time, when there is no substitute. The simple assumption of a decrease over time is represented by the curve.

Curves 210 and 220 cross at time τ*₀, when the forecasted yearly cost becomes higher than the forecasted yearly benefit of patent B₀. Note that, when one of the assumptions that the costs increase and the benefits over time does not hold true, the model becomes more complex: the form of the curves cannot be easily predicted and the displacement of the crossing of the curves either.

Curves 221 and 222 represent respectively forecasted benefits or rents for a patent B₁ and a patent B₂ which have different rents profiles: B₁ has always a value lower than B₀; curve 221 crosses curve 210 at time τ*₁, which is earlier than τ*₀; therefore patent B₁ should be abandoned earlier than patent B₀. Conversely, patent B₂ has a rent which is equal to the rent of B₀ at the beginning of its life and which becomes higher over time. Therefore, patent B₂ will be abandoned later than patent B₀ (at a time τ*₂).

Therefore, by analyzing a posteriori the statistics of patent renewals, it is possible to build a corresponding distribution of patent values. If it is possible to find variables which explain the statistical distribution of patent renewals, the same variables should also explain the statistical distribution of patent values.

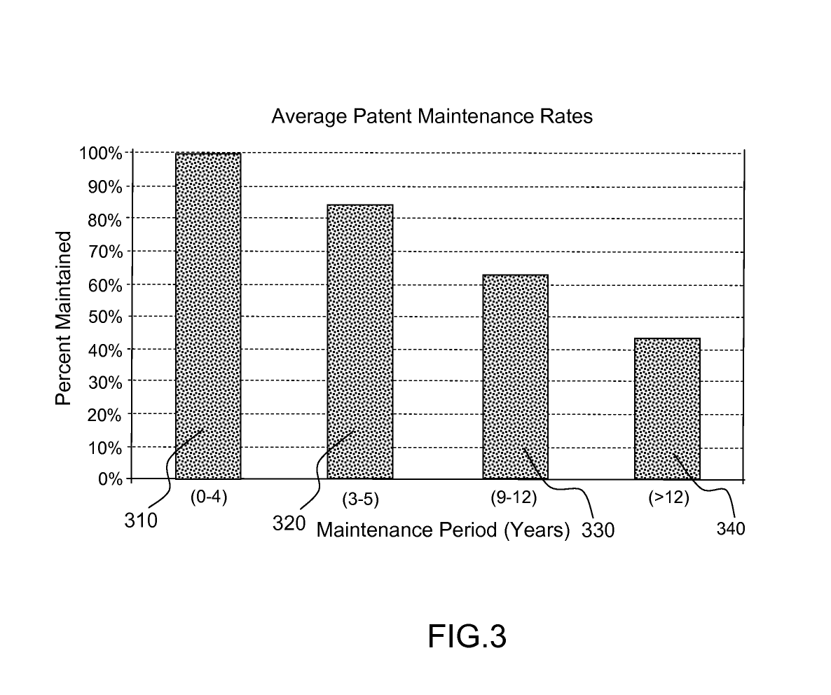

FIG. 3 illustrates the input data of a patent scoring model of the prior art.

This figure is abstracted from an article published by Jonathan Barney (A Study of Patent Mortality Rates: Using Statistical Survival Analysis to Rate and Value Patent Assets. AIPLA Quarterly Journal, Volume 30-3, p. 317. Summer 2002).

As already explained, In the US, patent maintenance fees are paid 4, 8 and 12 years after grant. Then no charge is levied to keep the patent in force until its expiry.

FIG. 3 displays average patent maintenance rates for a study population of approximately 70,000 patents issued in 1986.

Bar chart 310 displays a 100% maintenance rate for the 1^{st} maintenance period, since no maintenance fee is due during this period.

Bar chart 320 displays a 83.5% maintenance rate for the 2^{nd} maintenance period, which means that 16.5% of the 1^{st} annuities due for the patents issued in 1986 were not paid.

Bar chart 330 displays a 61.9% maintenance rate for the 3^{rd} maintenance period, which means that 38.1% of the 2^{nd} annuities due for the patents issued in 1986 were not paid.

Bar chart 340 displays a 42.5% maintenance rate for the 2^{nd} maintenance period, which means that 57.5% of the 3^{rd} annuities due for the patents issued in 1986 were not paid.

The probability that each of the 3 annuities be paid at their term can be expressed as a statistical variable which can be modelled to depend on a number of variables which characterise a population of patents the owners of which have the same maintenance behaviour. Such independent variables cited in the above referenced AIPLA publication are: the International Patent Class (IPC) and/or the US Class of the patent, which are indicative of the field of technology to which the patent pertains; the number of claims, which is positively correlated to the maintenance rate; the length of the independent claims, which is negatively correlated to the maintenance rate; the length of the specification, which is positively correlated to the maintenance rate; the number of priority claims, which is positively correlated to the maintenance rate; the forward citation rate (ie the number of later patents citing this patent relative to the number of later patents citing all the patents of the same age), positively correlated to the maintenance rate.

Patent professionals will know that some of these variables are heavily dependent on national regulations which impact on drafting and prosecution practice. In our case, some of the variables which are cited as having a significant impact on the maintenance rate of a US patent may not have any impact at all or, even, a reverse impact in other patent jurisdictions. For instance, the length of the independent claims cannot be the shortest possible in European practice, for fear of facing clarity objections, ie it is necessary to explicitly include in a claim all the features which are necessary to solve the problem of the invention. Also, the number of priority claims has very little variance in Europe since continuations are generally not allowed, whereas it is well known that in the US, important inventions will be patented under various angles in a significant number of continuations which claim the same priority. The number of citations is probably significant also in Europe, but citations in Europe and citations in the US cannot be directly compared, since in the US the applicant has a duty to disclose, and the citations are his, whereas in Europe, there is no such duty and the citations are those of the examiner.

Therefore, even if the assumption that maintenance rates are also indicative of the value of patents out the US (as demonstrated by Schankerman and Pakes in their publication cited above), the independent variables which have a statistical impact on said value are most likely different from the variables which have a statistical impact on the value of US patents.

But there are more fundamental statistical reasons for which the methods of the prior art cannot be applied at least to European patents. As patent practitioners will know, a European patent is granted as a single patent but has then to be validated in the countries where the patentee wants to be able to enforce his title, and annuities have to be paid every year in all these countries.

When looking in the prior art for a description of a statistical model to predict the probability that the maintenance fee of a patent be paid at a given age, we can only find an implicit reference to a model to predict the probability of a binary variable such as the probability to pay a maintenance annuity. Indeed, a man skilled in the art of statistics will understand the use of two populations having different characteristics (maintenance fee paid/not paid) to adjust the model parameters as an implied reference to a statistical model to predict a two states discrete or binary variable. Indeed, in such a model, what is modelled is the probability of occurrence of an event (payment/non payment); therefore, the data on which the model is trained need to have two distinct populations of instances having one feature and instances having the opposite feature. There are two classical kinds of binary models known to the man skilled in the art: the probit model and the logit model.

The mathematical representation of a probit model will be of the form: Pr(Y=1|X)=Φ(X′β) where Y denotes the occurrence of the event of interest to be modelled (1=occurrence, 0=no occurrence);

X a vector of independent variables which explain the variations of Y and β a vector comprising the parameters of the model which are generally determined using a maximum likelihood estimation; Φ is the Cumulative Distribution Function of the standard normal distribution.

Another method of modelling the probability of a binary variable such as the maintenance rate of an annuity is to use a logit model. The mathematical representation of a logit model will be of the form:

$$Pr ( Y = 1 \vert X ) = \frac{1}{1 + {e}^{- Z}} ;$$

z=β₀+β₁x₁+β₂x₂+β₃x₃+ . . . +βₖxₖ; xₖ denotes the regressors of the model and βₖ denotes the parameters of the model.

When dealing with renewal fees paid each year, probit an logit models cannot take due account of the decisions possibly made every year, under the condition that the patent is still alive. It would be possible to chain yearly maintenance data, each modelled by a probit or a logit statistic, under the condition that the patent is still alive when the decision to renew is made. But this is not disclosed by the prior art.

Dealing with multiple countries maintenance data can be done in at least two ways. One way, which is disclosed by U.S. Pat. No. 7,657,476 to Barney, is to compound each country maintenance data into a monetary value which is calculated from the costs of maintaining a patent alive and then converting all country values into a single value using the exchange rate of the currencies of each country. In this way, the relative economic importance of a country for the patent owners is not taken into account. On the contrary, it is probable that this method will overestimate patent values in a given country since small countries tend to levy higher maintenance fees than the large countries. Another way is to take due account of the relative weights of the countries where a patent is obtained to obtain a global score of the family of patents. This second method is not disclosed by the prior art.

It is an object of the present invention to overcome these drawbacks of the prior art.

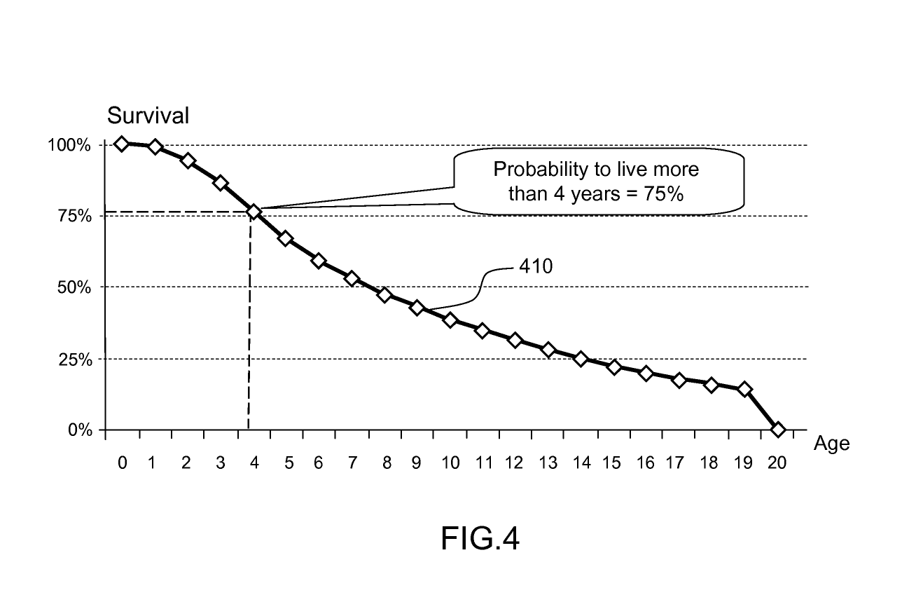

FIG. 4 illustrates a survival function of a population of patents according to an embodiment of the invention.

The present invention uses yearly maintenance statistics to predict the value of a definite patent. A survival model is defined to model the probability that a given patent will be alive at a given age. Such a model differentiates over a probit model inferred from the disclosure of US '992 in that the probability of survival at a given age can take into account the fact that the patent did survive at least as far at the age when the prediction is made. A survival model of the type used in the present invention is based on a continuous survival function and can take into account censored and uncensored data, ie both data for which the event to be modelled has not occurred yet on the observation date (censured data) and data for which the event to be modelled has already occurred.

A patent survival function 410 is displayed on FIG. 4. This function relates the probability that a patent will survive as a function of its age. The example of said FIG. 4 displays a survival function where, for instance, a patent has a probability of 75% to survive at least until age 4.

A survival function is defined as:

S(t)=P{T>t}=1−F(t)

where F(t) is the Cumulative Distribution Function (CDF) of the population.

The survival function gives the probability of surviving or being event-free until time t.

According to one preferred embodiment of the invention, the survival function is modelled by a Cox Proportional Hazard Model. A description of a model of this kind is given in Cox, D. R. (1972), Regression models and life-tables, London, Journal of the Royal Statistical Society.

An equation representative of the model used in a preferred embodiment of the invention is given below:

S(t,Xᵢ)=[S₀(t)]^{exp(X′}^{ᵢ}^{β)}

Where Xᵢ is a vector comprising the features of patent i, β is a vector comprising the model parameters and S₀ is the baseline function can be estimated using a Breslow estimator:

S₀(t)=e^{-H}^{₀}^{(t)}

where

$${H}_{0} ( t ) = {\sum }_{{t}_{i} \leq t} \frac{1}{{\sum }_{j ∈ {R}_{i}} {e}^{β \cdot {x}_{j}}}$$

(see Breslow, N. E. (1972), “Discussion of Professor Cox's Paper,” J. Royal Stat. Soc. B, 34, 216-217).

The method used to select the vectors Xᵢ comprising the features of patent i and the model parameters β taken into account in the model will be described further below in the description.

In another preferred embodiment of the invention, the survival function is modelled using an Accelerated Failure Time Model with a Weibull distribution. A description of a model of this kind is given in Nelson, W. (1982), Applied Life Data Analysis, New York, John Wiley & Sons: 276-293.

An equation representative of the model used in a preferred embodiment of the invention is given below:

S(t,Xᵢ)=S₀(t.e^{-X′}^{ᵢ}^{β})

where Xᵢ is a vector comprising the features of the patent I; β is a vector comprising the model parameters; S₀ is the Weibull base survival function.

The Weibull base survival function is of the type:

$${S}_{0} ( t ) = {e}^{- {( \frac{t}{{η}_{0}} )}^{{b}_{0}}}$$

where η₀ and b₀ are estimated simultaneously with β.

A patent characteristics vector Xi will only modify the scale parameter η of the time distribution function. A patent's life expectancy is therefore equal to:

$$E ( {X}_{i} ) = {E}_{0} \cdot {e}^{{X}^{′} , β}$$

$$with$$

$${E}_{0} = {η}_{0} \cdot Γ ( 1 + \frac{1}{{b}_{0}} )$$

The Cox model can be used to first select the independent variables which have maximum impact on the survival function. The list of candidate variables is determined by experts in the field of patent valuation, who base their input on the literature and on their judgment in relation to the specifics of patent laws, regulations and procedures in a definite jurisdiction. Therefore, the list of variables and their weight may be different from a jurisdiction to another. The candidate variables are then input in the Cox model using an iterative process. The Cox model has inbuilt statistical tests which allow selecting the explanatory variables by their explanatory power in the model. Then these variables are input in a Weibull model and the parameters of this model are calculated. This step allows the calculation of the relative impact of each independent variable on the life expectancy.

Alternatively or in a further step, a selection of variables can be made to define strata, using various criteria such as their impact on the dependent variable, the homogeneity of each strata and the heterogeneity across strata. A strata Cox model is defined for each strata. This selection of the variables which define the strata can be made by experts or using statistical tests. In a preferred embodiment, the strata can be defined using IPCs or USC (US patent codes); this approach is straightforward since all patents have at least one IPC code. However, there is not a perfect match between the IPCs and/or the USC and the business domains where the inventions may be used. Therefore, it is also possible to build a specific segmentation to define the strata, provided that all the patents in the database can be classified according to this segmentation.

We then use the same variables and the same stratification to adjust a Weibull strata model. A manner in which this method of the invention can be used is described further below in the description.

In a specific embodiment, it is possible to measure codependencies between two patents in different countries so as to better take into account the impact of an abandonment in one country on the lifetime in another country.

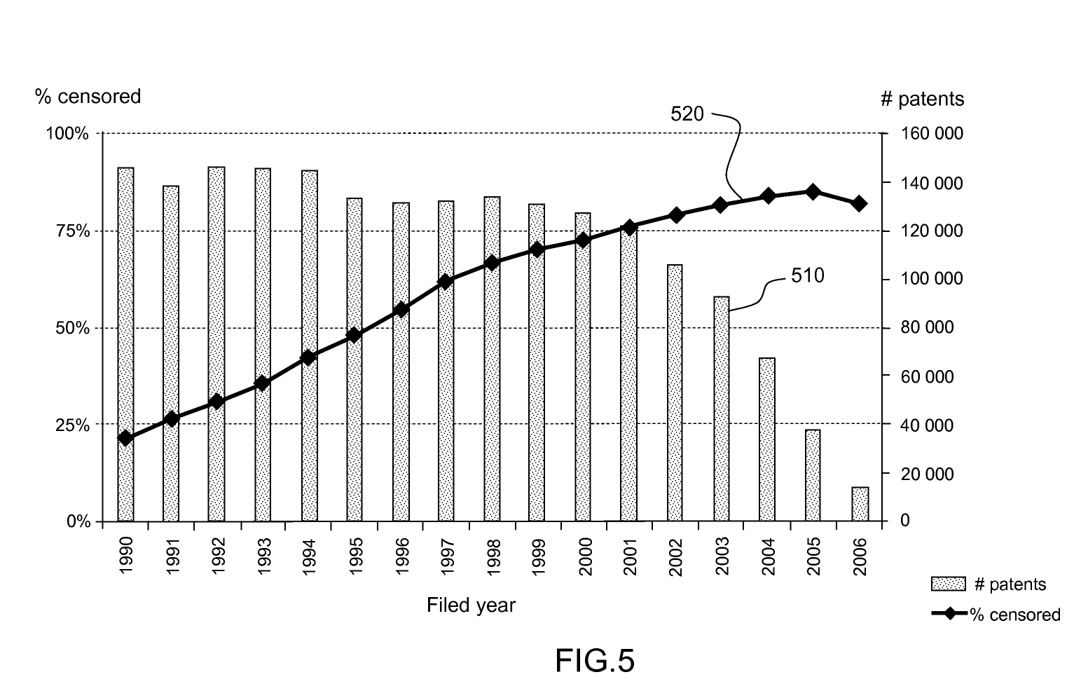

FIG. 5 illustrates a distribution by filing date of a patent sample and censored patents percentage in an embodiment of the invention.

A feature of the survival models used to embody the present invention is that they can take into account both uncensored data (ie data where the event to be modelled has occurred, in this case the abandonment of the patent) and censored data (ie, data where the event to be modelled has not occurred yet, in this case, patents which are still alive at the observation date).

FIG. 5 displays a sample used to calculate the model parameters with an indication of the distribution of the sample by application date (bars 510) and a representation of the percentage of censored data (line 520). Both the Cox model and the Weibull model have in-built procedures, described in the cited publications, to take due account of the censored data. This allows to include more data into both the learn sample and the test sample: rather than using only those patents with a recorded end of life if they are not renewed, this allows to leverage the full set of data that is available to teach the model, leading to more precise estimates and more accurate measurement of the performance of the model. Furthermore, restraining ourselves to non-censored data only would constitute a bias in the survival analysis, since the patents that were abandoned <<early>> would become too numerous compared to those with a <<late>> abandonment. Note that Probit-like models do not allow taking into account censored data but do not suffer any estimation bias when only the non-censored data are used to estimate the model. The estimation of the parameters they deliver is only less precise

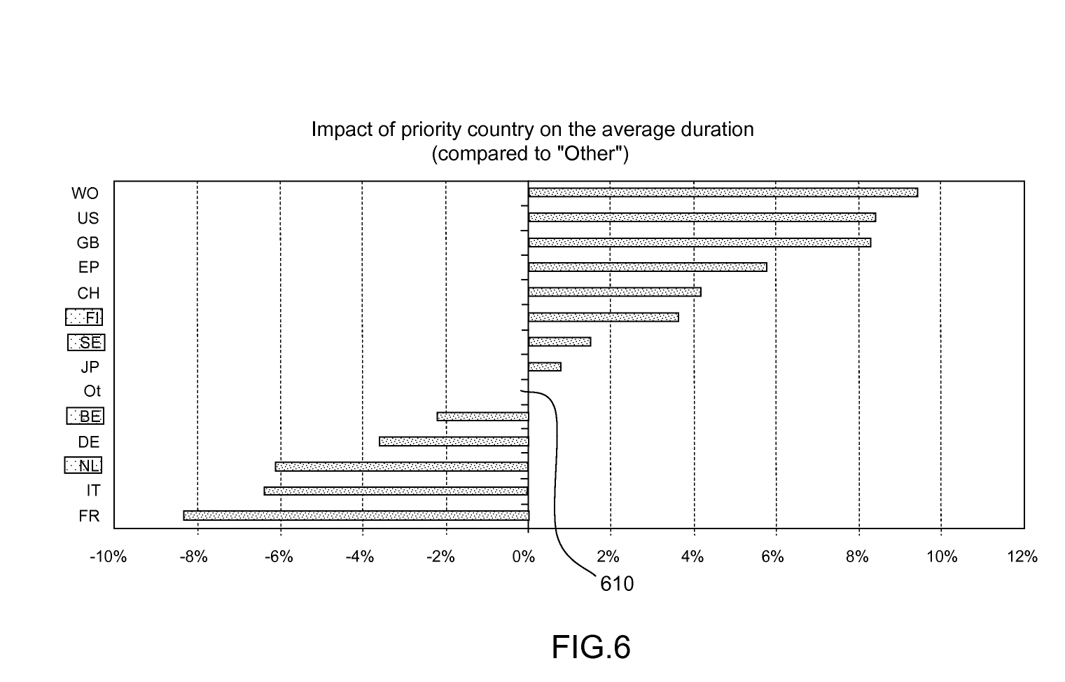

FIG. 6 illustrates an exemplary interpretation of the results of a survival model to analyze the impact of the priority country on the average lifetime of a patent in an embodiment of the invention.

A number of variables which represent the features of a population of patents are tested to assess the impact on the life expectancy of said patents included in this population (or the age at which said patents will be abandoned). Variables can be chosen initially without any preconceived idea. An indication that a variable may impact the life expectation in a jurisdiction is enough to include the variable in the model. Using a Weibull model of the type described in relation with FIG. 4, it is possible to measure the contribution of this variable to the variation of the life expectation of the population of patents. It is not necessary to adjust the parameters of the model on two populations having very distinct characteristics, as it is in a probit model.

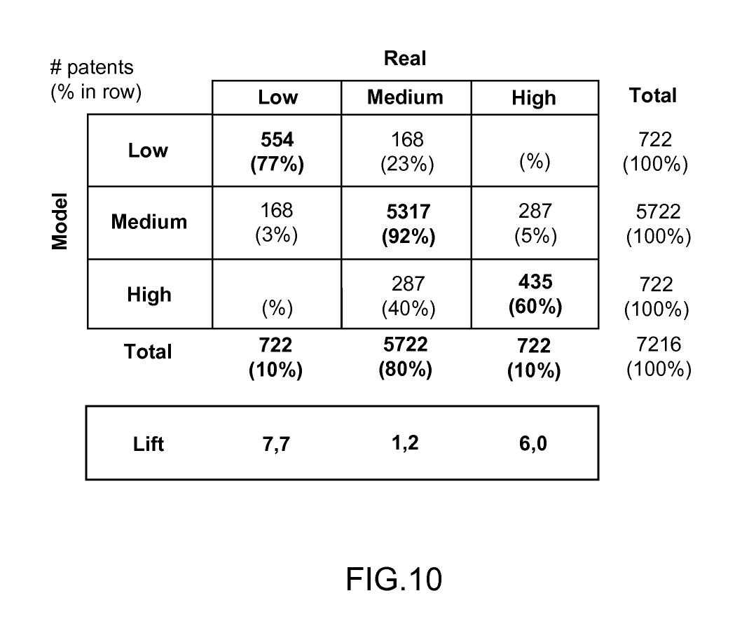

The procedure, which will be further explained in detail in relation with the flow chart of FIG. 10, first uses a Cox model. Classical statistical tests allow the selection of the relevant variables based on a “stepwise” algorithm. This is an iterative approach: at each step, candidate variables are considered for input in the model only if they bring (statistically) significant improvement to the model (forward selection). Then previously selected variables are tested again for significance (backward selection). This process stops when none of the available variables meets the criteria to be input into or withdrawn from the model. Significance of the variables can be tested using, for example, the Wald chi-square statistics and related significance test. This statistical selection is not run automatically, but rather guided by expert knowledge regarding the choice of the variables to test and the order in which it is advantageous to test them, as well as by the consideration of potential statistical artefacts to be avoided, such as over-fitting the model.

When this first selection has been achieved, the variables are input in a Weibull model which is constructed from the Cox model of the first step. All the variables that were selected during the Cox model estimation are used in the Weibull model estimation; still, all the parameters associated to these variables need to be re-estimated specifically for the Weibull model. Then, the statistical evaluation of the results of the Weibull model gives, among other results, the contribution of each variable to the total variation of the life expectation.

In the example of FIG. 6, the variable which is tested is the country of the application the priority of which is claimed by each patent in the population. The horizontal bars 610 represent the relative variation of each instance of the variable compared to a selected instance (in the example of FIG. 6, the instance chosen as a benchmark is the “Other countries” priority claim. Each bar represents the percentage whereby the priority claim in this country differs from the impact of a priority claim in the “Other countries”: a WO (or PCT) priority claim increases the life expectation of the patent by ˜9.5%. A US priority claim increases the life expectation of the patent by ˜8.5%. An Italian priority claim decreases the life expectation of the patent by ˜6.5%. A French priority claim decreases the life expectation of the patent by ˜8.5%.

The priority country is only illustrated by way of non limiting example of an embodiment of the invention. All kinds of other variables can be input in the model and tested as explained above. This procedure can be applied to numeric variables, like the number of designations of the patent, the number of words in the description of the patent, the number of claims of the patent, etc. . . . . The procedure can also be applied to alphanumeric variables like the designation country of the patent, the language of the patent, the International Patent Class, etc. . . . . For the IPC variable (the first IPC cited by the examiner), truncation of the code can be done at a chosen level (one, three digits or more), taking due account though of a minimum number of patents in the population to be evaluated so as to ensure statistical relevance.

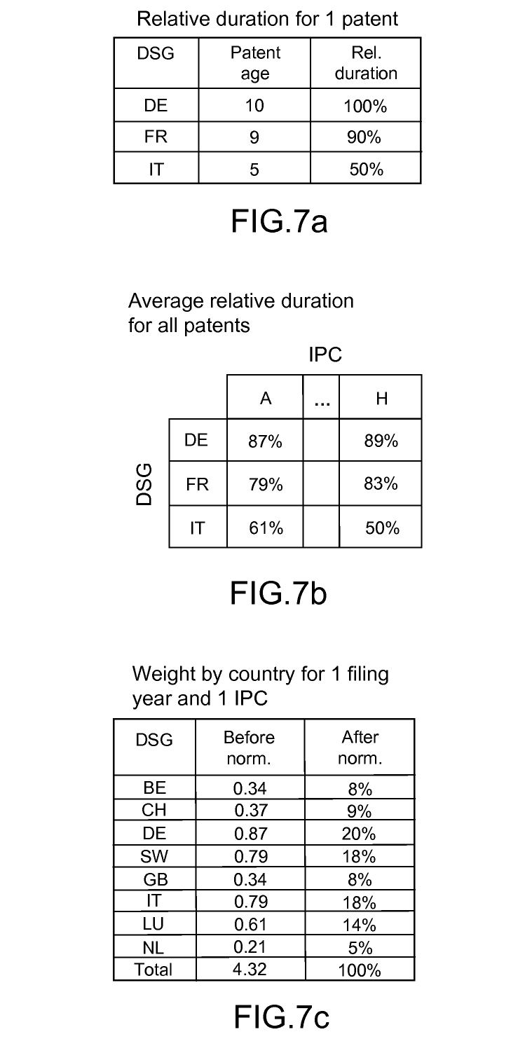

FIGS. 7a, 7b and 7c illustrate the computation of a global lifetime in multiple patent jurisdictions in an embodiment of the invention.

Europe is taken as an illustration of the problem that one faces to compound lifetime expectancies which are evaluated in different patent jurisdictions but belong to a single family. Generally, patents are considered to belong to a single family when they share at least one priority claim. This may include patents filed in different countries, but also divisional applications or continuations of a first application filed to the same patent office. In general, the patents of a same family will share the same description (or almost the same description, save for the language), but may have different sets of claims. The patentability (patentability of the claimed subject matter, industrial applicability, novelty, inventive step, clarity, unity of invention, formal requirements, etc. . . . ) may be assessed in view of different laws and/or regulations and by different patent offices.

The European Patent Convention (EPC) has been agreed in 1973 between a number of European countries to establish a single law, single regulations, a single procedure and a single organization to examine a single patent application and grant a single European patent. But the applicant had, until the entry into force of the revised EPC 2000, to designate the countries for which he intended to obtain patent protection. The designation took place at the time of filing and had to be confirmed one or two years later by the payment of designation fees. Then, at the time of grant, the patentee had to accomplish a validation procedure, ie a number of formalities, in the countries where he wanted to confirm the designations. Said formalities included possibly the deposit to the patent office of the country of validation of a translation of the specification of the patent into the language of the country of validation and the payment of a validation fee to this patent office. From thereon, maintenance fees had to be paid to keep each national instance of the validated European patent in force. From the entry into force of EPC 2000 (May 2008), a European patent (EP) application was deemed to designate all member States, and failure to pay the required designation fees one to two years after the date of filing became an abandonment of the EP application. Validation formalities were also amended on the same date for member States which ratified the London Agreement. But some validation formalities remain in force for most EPC member States and the requirement to pay national yearly maintenance fees also remains in force.

Therefore, to evaluate a population of European patents, it is necessary to take due account of the fact that a single European patent may not be validated in all EPC member States. In fact, most European patents are only validated in a small number of countries (5 on average for the issued patents filed between 1990 and 2009). Also, the European patent may be abandoned in each one of the countries where it was validated on different dates.

According to a preferred embodiment of the invention, the life expectancy of a patent in each of the countries where it has been validated on grant is first evaluated, using the method described hereinabove.

Then, the overall life expectancy of the patent in all countries of validation is evaluated, using a method to compound the life expectancies in all countries of validation.

In a first step of the method according to a preferred embodiment of the invention, the life duration for all the patents in the representative sample that is analyzed (learn sample) is calculated, including censored and uncensored data. This life duration is then used to calculate a relative duration of each patent validated in a definite country.

As can be seen on FIG. 7a, this relative duration is calculated by dividing the life duration in each definite country of validation by the life duration in the country where this life duration is the maximum of all countries of validation for the family of patents to be scored. Let's denote RLCᵢ this variable, LCᵢ the Life duration in Country Cᵢ and MLC the Maximum Life duration in all countries. The weighting coefficients will therefore be given for each country Cᵢ by the ratio RLCᵢ=LCᵢ/MLC.

The second step is to calculate the average of the relative life expectancy for all the patents in a country of validation in a definite IPC for all the patents in said IPC. The rationale for this calculation is that the number of countries of validation and the life expectancies in different countries may differ from one IPC to another. It is possible to use the one digit or three digits IPC codes, but the process must remain manageable and the user may also decide not to account for these differences if he so elects. This second step of the method according to a preferred embodiment of the invention is illustrated by FIG. 7b.

The third step is to calculate, for each one or three digits IPC a normalized weight for the patents validated in a definite country. The normalized weight is defined by taking into account, for a definite year of filing, all the patents validated in this country, when this country was available for designation at the time of filing the patent application. The rationale for this calculation is that the list of countries available for designation varied over time (Member States joined the EPC at different years). This third step of the method according to a preferred embodiment of the invention is illustrated by FIG. 7c.

Other options may be contemplated to account for the impact of the life expectancies in the different countries of validation on the overall life expectancy of a patent or a population of patents.

For instance, in lieu of the first step, we can calculate, for each country of validation, a relative rank of this country in the time ordered sequence of abandonments. Let's denote RRCᵢ this variable, RDCᵢ the Rank of Death in Country Cᵢ and NAC the Number of Available Countries. NAC is the number of countries which were available for designation at the time of filing of the EP application. NAC is a normalizing coefficient which it is necessary to use since NAC varied over time, some member States having joined the EPC rather recently. The weighting coefficients will therefore be given for each country Cᵢ by the ratio RRCᵢ=RDCᵢ/NAC.

Other options may also be contemplated to account for the relative economic value of the invention in the countries of validation for different IPCs. For instance, the share of the gross domestic product in a country in these IPCs may be used in lieu of the average relative life expectancies as an input to the third step of the method. IPCs may not be judged as adequate to match the business domains where the inventions are actually used. Therefore, the IPC codes may be replaced by another segmentation which would better represent these business domains, provided however that rules to map the patent database to each segment are properly defined.

When the three steps of the method according to a preferred embodiment of the invention have been performed, we can calculate a life expectancy or a score of the patent family in all countries of validation by multiplying each life expectancy in all countries of validation by its country weight calculated as the output of the steps described hereinabove.

According to some embodiments of the invention, it is also possible to score patent applications, provided however that maintenance data on the applications are available to feed the databases used to compute the model parameters (data that is not available at the time can be replaced using standard missing values replacement algorithms). For instance, backward and forward citations are not easily available in the US before grant. Maintenance data are not currently available for EP applications, but should be available in the short term.

It is important to note that, in most jurisdictions, patent applications cannot be enforced to the same extent as issued patents. Therefore, a patent application cannot be deemed to have the same value as an issued patent. Also, in Europe, there is an uncertainty before grant regarding the countries where the patent will be validated.

A probability of grant can be allocated to patent applications which have not yet matured to grant, said probability of grant being computed from the passed statistics of grant for a population of patents of the same filing year. Likewise, a probability of validation in a list of countries can be allocated to a European patent which has been granted. This can be achieved using a probit/logit statistical model of the type described above, the dependent variable being the validation/non validation of a country which has been designated at the time of filing, the learn and validation samples being defined by the histories of validation until a definite observation date. According to this embodiment, multiplying the life expectancy and the calculated probability of grant gives an estimate of a new (smaller) life expectancy that accounts for the risk of not being validated in the country.

What has been described for European patents can be extended to a family of patents in jurisdictions where different patent offices will apply different laws, regulations and procedures: life expectancies will be first calculated with Cox/Weibull models compounded for example in the manner explained hereinabove in relation with FIG. 4. Then the life expectancies of the patents of a given family will be compounded using weighting coefficients of the type explained for European patents or patent applications.

At the end of the process of the invention, an aggregate patent family score/rating can be calculated for a given population of patents/patent applications.

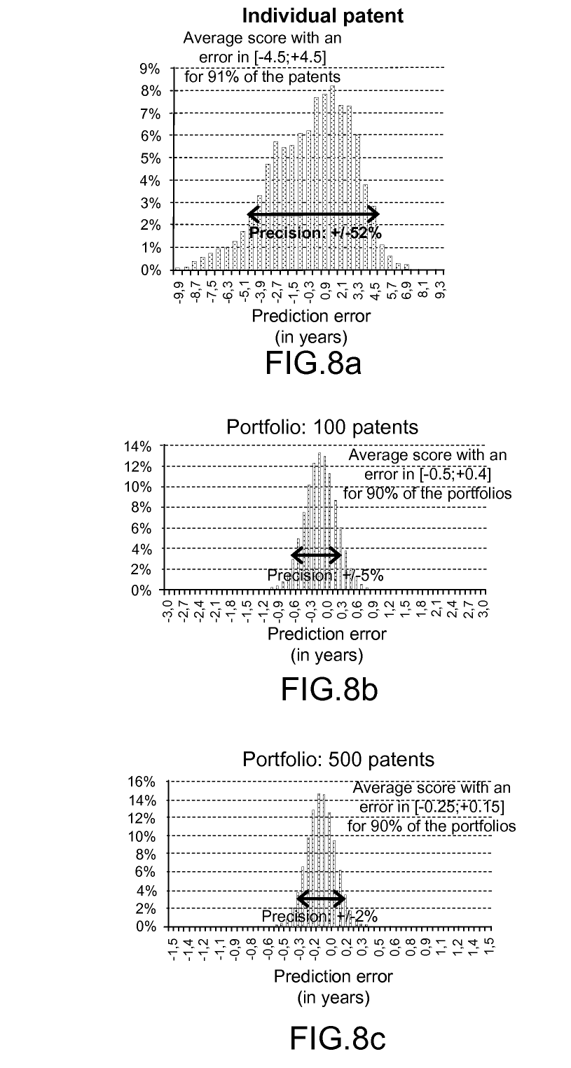

FIGS. 8a, 8b and 8c illustrate the theoretical calculation of the confidence level of the lifetime computation in an embodiment of the invention.

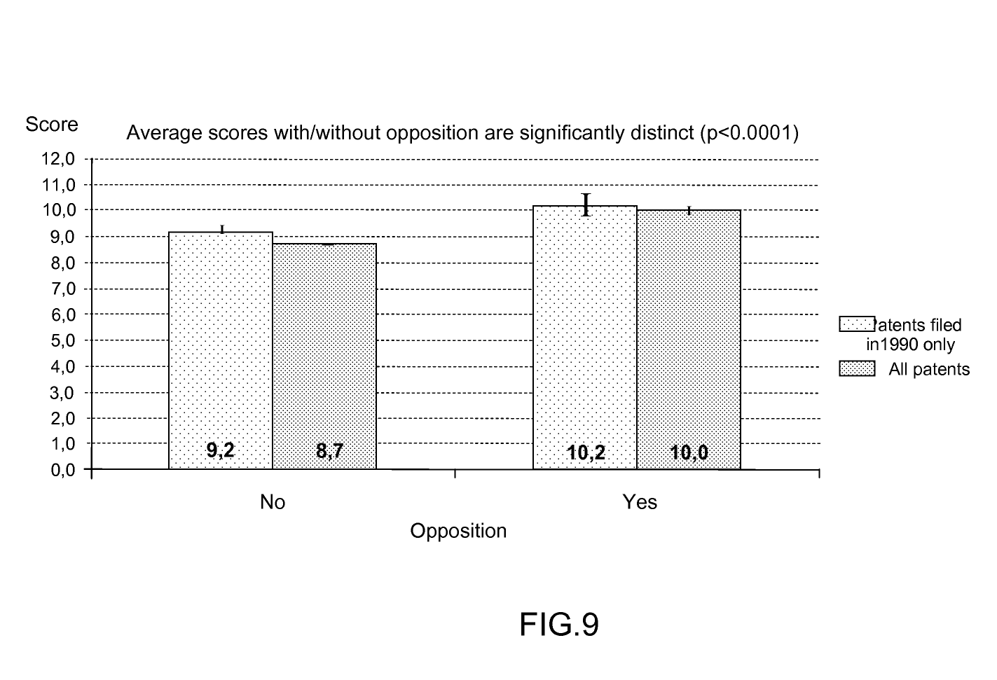

These figures illustrate the limitations of all statistical models when coming to evaluate their predictive power. It is well known that a statistical model will better predict a variable—in our case the average life expectancy of a group of patents—for a large group of patents for which a mean of the variable will be predicted than for a small group or for a single patent. FIG. 9a shows that, according to a theoretical calculation on the statistics of a model of the type described hereinabove, the precision of the prediction is such that the variance of the evaluations is not better than 52% of the predicted value for a single patent. As displayed on FIG. 9b, for a population of a 100 patents, the precision of the prediction is much better (5%). As displayed on FIG. 9c, for a population of 500 patents, the precision of the prediction is 2%.

As will be explained further in the description, these theoretical calculations of the predictive power of a model are advantageously supplemented by user tests which take into account the objectives of the user in performing an evaluation with this model.

FIG. 9 illustrates a practical computation of a confidence level for a specific variable which impacts the lifetime of a patent in an embodiment of the invention.

Another way to assess the value of a statistical model is to verify that the model prediction is actually correlated with another variable (not used in the model), which is known to be correlated to the dependent variable of the model, is predicted with a confidence interval which is statistically acceptable. In the example of FIG. 10, the “new” variable which is tested is the occurrence of an opposition to the patent. Two groups of patents are defined in our test sample: the group of opposed patents and the group of non-opposed patents. The dependency between the predicted score and the occurrence of the event can be assessed by testing whether the score averages in each group are statistically different. Here, the average score amongst the non-opposed patents is equal to 8.7 vs. 10.0 in the group of opposed patents (respectively 9.2 and 10.2 when restricting the groups to patents filed in 1990 only). It is generally admitted by the man skilled in the art, that opposed patents have a higher value than non opposed patents because they raise the interest of third parties. More interestingly, statistical test shows that these differences are statistically significant, with a confidence that is generally considered more than sufficient by the man skilled in the art (p-value<0.0001).

What has been described for the opposed/non opposed dependent variable can be also applied to another dependent variable which is correlated to the value of a patent. Examples of other variables which can be tested are: licensed/non licensed, litigated/non litigated, etc. . . . . Other tests can also be performed, like a correlation between the score calculated by the model based on predicted life expectancies and the real “observed” score based on the actual life durations A regression analysis can be performed on the two series of variables to assess the level of confidence of the correlation.

FIG. 10 displays the computation of a user test to assess the predicting power of a model in an embodiment of the invention.

When a patent life expectancy model has been statistically validated, a user may want to assess if the model fits his/her expectations. One of the preferred usages of the scoring models of the type of the invention is to determine the high and low scores in a given population. By way of example, it is assumed that the proportion of high value patents may be of the order of 10% of a given patent population, the proportion of low value patents being of the order of 10% of the same population. The proportion of medium value patents is therefore in this case of 80%. The user will therefore want to primarily check that the high/low scores are better predicted than if he would have applied a model distribution random (10/80/10).

The table of FIG. 10 indicates that the model tested in this example does deliver what the user wants: for a total population of 7216 patents, the number of low scores from the model is 722 (10%×7216), of which 554 (77%) belong to the lowest decile of the population of patents ranked by actual life duration. The predictive power, or lift, for low scores can be measured by the ratio of the detected low scores to their marginal distribution. In the example, the lift is 7.7 (77%/10%). Likewise, the number of high scores from the model is 722 (10%×7216), of which 435 (60%) belong to the highest quintile of the patents ranked by their life duration. The lift of the model for the high scores is therefore 6 (60%/10%). The lift for the medium score patents is much lower (1.2 in the example). But it can be noted that the proportion of false high/lows within the medium population is lower than is the marginal distribution.

According to another embodiment of the invention, different strata Weibull models can be applied, each strata being defined by a decile (or quintile, or another partition of the learning/test samples) of the original population of patents (subject to a minimum number of patents in the population to be scored)

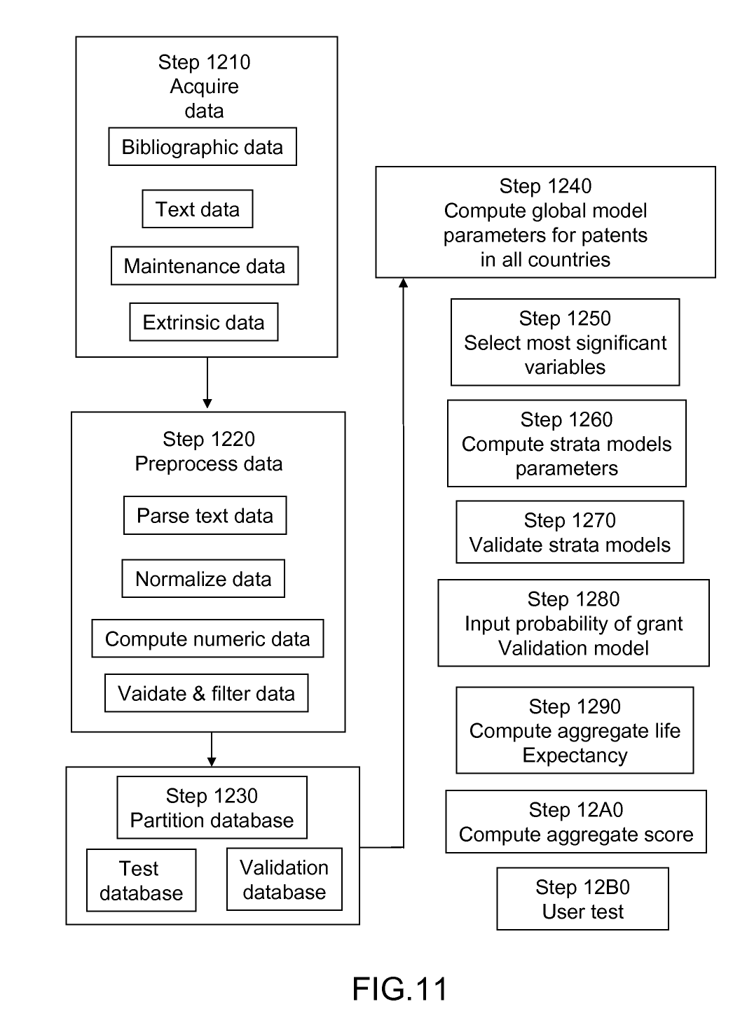

FIG. 11 displays a flow chart of a process to implement an embodiment of the invention.

Patent databases can be huge (4 million of granted US patents; 2 million of European patents and EP applications, for instance). Generally, data of the type needed to implement the invention will be available from the patent offices, from INPADOC™ or from private vendors, such as Questel™ or Thomson Reuters™. Also, it may be necessary to acquire data from multiple sources, if it is desired to score patents filed in more than one jurisdiction, to cross-check data or to include data from other sources than patent offices, for instance economic data relevant to the value of the patents to be valued, such as the value of production in a given field of economic activity.

Step 1210 of an exemplary process to implement the invention is targeted at this goal of acquiring all the data which are thought to be relevant to a patent evaluation to be performed. Bibliographic data relate to the different identification numbers which are assigned by a patent office to a given patent document (application number, publication number, grant number), the identification of the applicant(s), the identification of the inventors, data relating to the priorities claimed, to the representative, title and abstract, backward and forward citations (patent and non patent publications cited in the patent or citing the patent, possibly with a relevance qualifier—used to asses novelty and/or inventive step; citation by the applicant; background prior art), among others. Text data will generally consist of the description, the claims and the drawings. Maintenance data are also made available by the patent offices or private vendors and are necessary to implement the invention. Extrinsic data, for instance the value of production in a given economic field can be obtained from various sources, generally different from the patent offices (Sector Identification Code, Securities and Exchange Commission filings, marketing studies, etc. . . . )

A pre-processing step, 1220, is then generally needed. It will be advantageous to input all data from multiple sources in a single database having a unified data dictionary. Preferably, the data will be acquired or transformed in XML format. Depending on the independent variables that will be tested, it may be necessary to parse the text data to calculate numerical variables and/or extract alphanumerical fields. Also, some data may need to be normalized. By way of example, forward citations are heavily time dependent: as a patent ages, it will naturally be cited more often. Therefore, the relevant independent variable is not the raw number of forward citations, but an index representative of the number of citations as a proportion of all patents of the same age, possibly also normalized for the variance of the distribution of citations at a given age (with possibly an IPC normalization as well). Numerical data will generally have to be computed from the bibliographic, text and maintenance data (total number of claims, number of words in claims/description, number of figures, age from filing, age from publication, age from grant, etc. . . . ). Maintenance data may have to be cross-checked and filtered. For instance, since maintenance fee payment can be made after the due date for a grace period of generally six months, and lapsed patents may be restored if the patentee has a good reason to justify non payment, it is necessary to determine if, at a moment in time, based on the available information and on the grace period and restoration rules, a patent which is not marked as in force in the public databases is indeed alive or must be deemed lapsed.

Once the data has been prepared as explained hereinabove, it is desirable to partition the database in two samples (Step 1230), one to teach or adjust the models to be built and one to validate the models. It is important to note that there is absolutely no requirement according to the invention, that the two samples have different features, as it is in the prior art. On the contrary, the two samples are built to have the same characteristics in relation to a number of control variables, such as date of filing, country of designation/validation, IPC (for example).

Then, in a step 1240, a selection of independent variables present in the adjustment database output from step 1230, are fed to a life expectancy model, for example of the Cox Proportional Hazard type, and the parameters β are calculated. The variables which are deemed to be relevant are selected based on classical statistical tests (Step 1250), as explained above. These same variables may then possibly be input to a second model (Step 1260), for example of the Accelerated Failure Time (with Weilbull distribution) type to extract either a second, more accurate model, with more explanatory power, or a number of strata models, each model being tuned to an instance of an independent variable, for instance the IPC (one or three digits code). The model(s) are then validated on the validation database (Step 1270).

It may be then necessary to take into account the probabilities that a patent in a given country mature to grant and/or be validated in said given country (Step 1280).

An aggregate life expectancy may be then calculated based on the life expectancies output from the selected model for the countries where a patent application was filed and on weighting coefficient computed as explained hereinabove in relation to FIGS. 7 and 8 (Step 1290).

Then, an aggregate score can be calculated by ranking all the patents/patent application of a given population by their life expectancy (Step 12A0). A baseline score of 100 can, for instance, be defined as the average life expectancy of this population. Therefore a score of 50 will mean that a given patent will have half the average life expectancy and a score of 200 will mean that this given patent will have twice the average life expectancy. Also, ratings can be defined in addition to scores or as a substitute. Classically, ratings are defined by deciles or quintiles and marked by a letter (A, B, C, etc. . . . ).

If required, a user validation step (12B0) can be performed to check that the targeted users of the model will find benefits in the model. According to a preferred embodiment of the invention, the validation test described hereinabove in relation to FIG. 11 will be used.

According to specific embodiments of the invention, some of the steps can be omitted (for instance step 1220 of pre-processing, or some of the sub-steps; step 1260 of computing strata model, etc. . . . ). Also, the order in which the different steps of the method are performed is not material to the invention, save for what is logical in the context of the implementation of the invention.

When a model has been validated, scores can be produced for a whole population of patents provided that the data representative of the variables selected in the model are “industrially” available, ie may be updated from time to time. This requires a computer system, a database which is regularly updated, a network to allow connections from the users and a man machine interface. Various usage scenarios can be implemented: a user may be allowed only to input a patent number and will be returned the score of this patent. The user can also get various additional information about this patent, the patents in the same family, the same class, the same assignee, etc. . . . . He can be offered a breakdown analysis of the explanatory power of each variable on the overall score, if it is decided to be 100% transparent. He could also be offered the possibility to simulate a score of a patent having a number of given features, which are disclosed to impact the score. He can also be offered the choice between different models which are each adapted for a definite situation. For instance, the choice between the use of 1 digit or 3 digits IPCs.

The examples which have been described hereinabove are only a number of specific embodiments which do not limit the scope of the invention, which is defined by the appended claims.

1. A computer system for scoring at least one patent/patent application, said system comprising:
a database of patents/patent applications filed in at least one jurisdiction;
said database comprising data representative of the maintenance fees paid or not paid at each payment term for a collection of patents/patent applications comprising said at least one patent/patent application, and,
data representative of variables which are related to said maintenance fees paid or not paid at each payment term,
a statistical model representative of said relations between said variables and said maintenance fees paid or not paid at each payment term,
wherein said statistical model takes into account at least one of a yearly survival probability of payment of maintenance fees and maintenance data in more than one jurisdiction.

2. The computer system of claim 1, wherein said statistical model takes into account a yearly survival probability in more than one jurisdiction.

3. The computer system of claim 1, wherein the parameters of said statistical model are adjusted on a first subset of said database and validated on a second subset of said database, said subsets comprising uncensored and censored data.

4. The computer system of claim 1, wherein said statistical model is of one of a parametric or semi-parametric type.

5. The computer system of claim 4, wherein said model is one of a Cox proportional hazard model and an accelerated failure time model with a Weibull distribution.

6. The computer system of claim 5, wherein said model is one of a proportional hazard Cox model which is stratified and an accelerated failure time model with a Weibull distribution model which is stratified.

7. The computer system of claim 6, wherein the strata of the stratified model are one of the international patent classes, the US patent classes and classes representative of the economic activities.

8. The computer system of claim 7, wherein the strata of the stratified model are defined by the three digits international patent classes codes.

9. The computer system of claim 4 wherein a first model of a semi-parametric type is first used to select the variables which have a statistically significant impact on the life expectancy of a patent and a second model of a parametric type is then used to with the same variables to determine best fit parameters.

10. The computer system of claim 1, wherein maintenance data in more than one country are compounded to determine an overall score of said patent/patent application by weighting the maintenance data of each country by one of the rank of the death the patents/patent applications in a country relative to the number of available countries at the time of filing of said patents/patent applications and the life expectancy in a country relative to the maximum life expectancy of said patents/patent applications in the countries where they were filed or could have been filed.

11. The computer system of claim 10, wherein different country weights are calculated for one of each international patent classes, each US patent classes and each of a series of classes representative of the economic activities.

12. The computer system of claim 10, wherein the country weights are normalized for the countries available for designation at the time of filing the patent applications in the database.

13. The computer system of claim 1, wherein the predictive power of the model is assessed by comparing the high/low scores predicted by the model to the actual high/low scores measured from the statistics of an overall sample.

14. The computer system of claim 13, wherein the high/low score patent families defined by set cut-off percentiles of scores are withdrawn from the database, wherein the remaining database is used to define different stratified statistical models wherein strata are defined by groups of percentiles of scores.

15. The computer system of claim 1, wherein the life expectancy of a patent application with certain features is calculated as the product of the life expectancy of a patent with said features having matured to grant by the probability of grant.

16. A computer process for scoring at least one patent/patent application, said process comprising:
populating a database of patents/patent applications filed in at least one jurisdiction;
said database comprising data representative of the maintenance fees paid or not paid at each payment term for a collection of patents/patent applications comprising said at least one patent/patent application, and,
data representative of variables which are related to said maintenance fees paid or not paid at each payment term,
estimating a statistical model representative of said relations between said variables and said maintenance fees paid or not paid at each payment term,
wherein said statistical model takes into account at least one of a yearly survival probability of payment of maintenance fees and maintenance data in more than one jurisdiction and a user obtains a score said patent/patent application from said model

17. The computer method of claim 16, wherein said user is given a breakdown analysis of the explanatory power of each variable on the overall score

18. A computer process for scoring at least one patent/patent application, said process comprising:
populating a database of patents/patent applications filed in at least one jurisdiction;
said database comprising data representative of the maintenance fees paid or not paid at each payment term for a collection of patents/patent applications comprising said at least one patent/patent application, and,
data representative of variables which are related to said maintenance fees paid or not paid at each payment term,
estimating more than one statistical model representative each of some of said relations between said variables and said maintenance fees paid or not paid at each payment term,
wherein said statistical models takes into account at least one of a yearly survival probability of payment of maintenance fees and maintenance data in more than one jurisdiction and a user is given the option to choose the scoring model and obtains a score for said patent/patent application from the model he chooses.
